(19) United States
(12) Patent Application Publication
(10) Pub. No.: US 2007/0039446 A1
(43) Pub. Date: Feb. 22, 2007

(54) Guitar hangar

(76) Inventor: Christopher Samu, El Cerrito, CA (US)

Correspondence Address: DERGOSITS & NOAH LLP;Attn: Michael E. Dergosits, Suite 1450, Four Embarcadero Center, San Francisco, CA, 94111, US

(21) Appl. No.: 11/210,237

(22) Filed: Aug. 22, 2005

(51) Int. Cl. G10G 5/00; G10D 3/00

(52) U.S. Cl. 84/327

(57) ABSTRACT

A guitar hangar for hanging a guitar having a neck and head on a closet rod. The hangar has a shaft having a longitudinal axis, a proximal end and distal end. The proximal end is configured in the shape of a hook sized to receive the closet rod. A set of prongs are located at the distal end and are spaced from one another to receive the neck of the guitar there between but not the head portion of the guitar.

### TECHNICAL FIELD

The present invention is directed to a simple yet effective device for storing and hanging a musical instrument such as a guitar. The invention is elegant in its simplicity and yet is capable of storing a guitar in a closet; a location safer and more appropriate than traditional storage devices.

### BACKGROUND OF THE INVENTION

Guitar storage has been somewhat of a challenge to musicians over the years. Professional musicians often times own more than one guitar and, in some cases, many guitars, both acoustic and electric and storing them has proven problematic.

Most guitars are kept in their own dedicated cases to both protect the guitar and to keep the instrument relatively dust and debris free. Although not an elegant solution, many musicians routinely place their guitars back in their cases and simply push the cases under a bed or furniture in order to hide them from view. Obviously, this is hardly a solution to a storage problem that musicians find ideal. Nevertheless, more acceptable alternatives have not been made commercially available.

In a review of the prior art, it is noted that U.S. Patent No. 5,372,346 suggests hanging a guitar from a cushioned swivel hook which is in turn screwed or otherwise mounted on a vertical surface such as a wall. In doing so, not only is the guitar exposed to the exterior of the wall, but it is exposed to dust and other fouling debris which generally accumulates on household furniture and appliances. Most musicians would find the swivel hook of the '346 patent a poor alternative to guitar case storage.

U.S. Pat No. 5,911,396 discloses a closet guitar hangar which is rather complex in construction requiring upper and lower frame members which engage one another to provide a hangar which is adjustable. However, such a hangar must be disassembled in order to enable it to engage and thus be supported by a suitable closet rod and, in operation, the frame members are capable of disengagement which could result in a catastrophic drop of the guitar to the floor below.

It is thus an object of the present invention to provide a guitar hangar which not only performs well in supporting a guitar but is quite simple to manufacture and use, thus encouraging its use by instrument owners.

This and further objects will be more readily appreciated when considering the following disclosure and appended claims.

### SUMMARY OF THE INVENTION

The present invention is directed to a guitar hangar for hanging a guitar having a neck and head on a closet rod. The guitar hangar includes a shaft having a longitudinal axis which extends vertically when the guitar hangar is employed. The shaft includes a proximal end and a distal end. The proximal end is configured in the shape of a hook sized to receive a closet rod and a set of prongs are located at the distal end, the prongs being spaced from one another to receive the guitar neck there between but not the head.

### BRIEF DESCRIPTION OF THE FIGURES

FIG. 1 is a prospective view of the guitar hangar of the present invention.

FIG. 2 is a partial prospective view of the preferred distal end of the guitar hangar of the present invention.

### DETAILED DESCRIPTION OF THE INVENTION

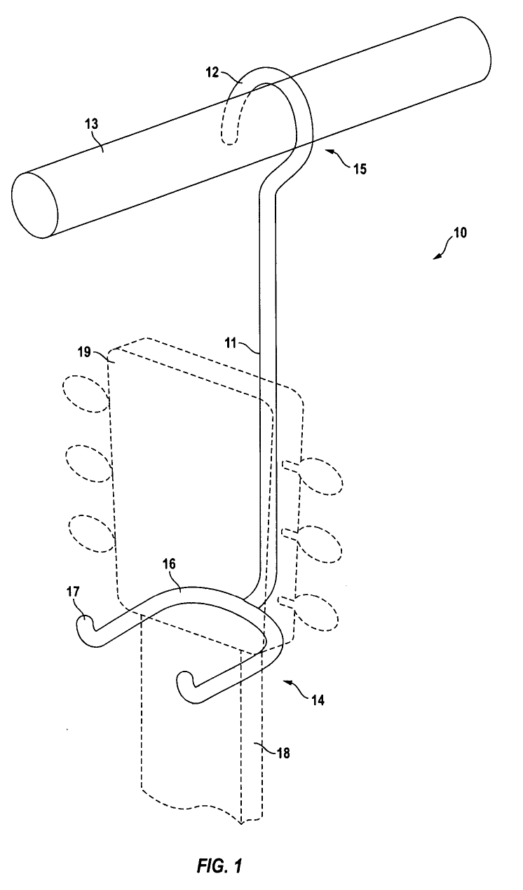

Turning first to FIG. 1, guitar hangar 10 is shown as a first embodiment. Guitar hangar 10 includes shaft 11 having a longitudinal axis with proximal end 15 and distal end 14 located at the extremities of shaft 11.

Proximal end 15 of guitar hangar 10 includes a hook 12 sized to typically slide over and engage closet rod 13 as shown. As such, applying guitar hangar 10 and removing it from a closet installation is no more difficult than applying a shirt, coat or pant hangar to closet rod 13.

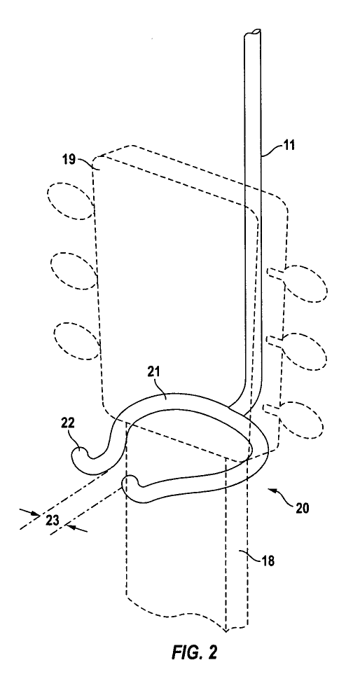

Distal end 14 of guitar hangar 10 is shown in two iterations in FIGS. 1 and 2, the iteration of FIG. 2 being most preferred. Specifically, distal end 14 can consist of a C-shaped tube or rod member 16 having upturned ends 17. Upturned ends 17 are spaced apart from one another along shaft 16 such that a typical guitar having neck 18 and head 19 would fit within and be supported by distal end 14 as shown in phantom. Ideally, shaft 16 is applied, by welding or other attachment means, substantially perpendicularly to the longitudinal axis of shaft 11 such that in operation, shaft 11 hangs substantially vertically while shaft 16 remains in a substantially horizontal orientation.

Although the embodiment shown in FIG. 1 operates in an acceptable fashion to support a suitable guitar, the embodiment of FIG. 2 is more preferred. In this regard, distal end 20 is shown such that C-shaped member 21 is provided with converging ends 22 in contrast to the upturned ends 17 of the embodiment of FIG. 1. Ideally, converging ends 22 are spaced apart from one another shown as spacing 23 such that neck 18 is capable of passing between converging ends 22 in a first orientation but not in the second orientation. Stated differently, one employing the embodiment of FIG. 2 would turn a guitar such that its neck would be introduced to distal end 20 from its side and once the neck region is captured by distal end 20, the guitar is then turned 90 degrees to sit within distal end 20 as shown in phantom in FIG. 1. In such an orientation, it would be very difficult to inadvertently disengage a guitar from the present hangar assembly for to do so, one would first have to rotate the guitar 90 degrees to present its narrowed side neck dimension to spacing 23 and pull the guitar from the hangar assembly in this orientation. There is no guitar hangar currently available which is both simplistic to manufacture, easy to use and yet ensures that inadvertent dislodgment is virtually eliminated.

Hangar 10 of the present invention, as noted, is quite simple to manufacture. For example, shaft 11 and proximal end 15 can be configured from a single piece of rod or tubular stock. Ideally, these elements could be bent from a single piece of stainless steel rod. Distal ends 14 or 20 could then be welded or otherwise secured to shaft 11 as being the only physical connection required in completing the present invention.

Although others have suggested hanging guitars in a closet environment, the present invention takes advantage of this environment while, again, providing a device much simpler to construct and use than those suggested in the prior art. Hanging guitars in a closet provides a degree of safety which is unmatched in wall hanging installations. Guitars tend to be cushioned by adjoining clothes and are placed out of plain view to minimize thievery. Also, closets tend to be less dusty than outside room environments noting further that a typical clothes bag could be placed over a guitar in such uninstallation providing further protection from dust and other debris as well as in hiding the guitar from unwanted intruders.

1. A guitar hangar for hanging a guitar having a neck and head on a closet rod comprising a shaft having a longitudinal axis, a proximal end and a distal end wherein at said proximal end is configured a hook sized to receive said closet rod and a set of prongs located at said distal end, said prongs being spaced from one another to receive said neck there between but not said head.

2. The guitar hanger of claim 1 wherein said shaft and hook are configured from a single piece of cylindrical stock.

3. The guitar hangar of claim 1 wherein said set of prongs are characterized as having upturned ends for engaging said head and to substantially prevent said guitar from inadvertently disengaging from said hangar.

4. The guitar hangar of claim 1 wherein said set of prongs are characterized as having converging ends spaced apart from one another such that said neck is capable of passing between said prongs in a first orientation, but not in a second orientation.
